(19) United States
(12) Patent Application Publication
(10) Pub. No.: US 2025/0030122 A1
(43) Pub. Date: Jan. 23, 2025

(54) FREE-STANDING SULFIDE SOLID ELECTROLYTE MEMBRANE AND ALL SOLID-STATE BATTERIES COMPRISING THE SAME

(71) Applicant: Factorial Inc., Woburn, MA (US)

(72) Inventors: Fang Hao, Andover, MA (US); Daniel Wakaba, Lawrence, MA (US); Hyun Seok Kim, Lexington, MA (US); Minh Nguyen, Lowell, MA (US); Joanna Burdynska, Woburn, MA (US)

(21) Appl. No.: 18/772,426

(22) Filed: Jul. 15, 2024

Related U.S. Application Data
(60) Provisional application No. 63/549,047, filed on Feb. 2, 2024.
(60) Provisional application No. 63/514,465, filed on Jul. 19, 2023.

(51) Int. Cl. H01M 50/446; H01M 10/0562; H01M 50/403

(52) U.S. Cl. CPC H01M 50/446; H01M 10/0562; H01M 50/403; H01M 2300/008

(57) ABSTRACT

This disclosure relates to a solid electrolyte membrane free of scaffold layer. In one embodiment, the membrane has a lithium-ion conductivity of at least 40% higher than the one prepared with a scaffold layer. Electrochemical devices such as all solid-state battery comprising the solid electrolyte membrane exhibit an improved cycling performance. Methods for preparing the solid electrolyte are also disclosed.

### CROSS-REFERENCE

The present application claims priority of U.S. Ser. No. 63/549,047, filed Feb. 2, 2024 and 63/514,465, filed Jul. 19, 2023, the entire content of which are incorporated herein by reference into this application.

### FIELD

This disclosure relates to a free-standing sulfide solid electrolyte membrane and all solid-state batteries comprising the same.

### BACKGROUND

All-solid-state batteries (ASSBs) are being extensively studied due to their better safety and higher energy density in comparison to conventional lithium-ion batteries which are based on organic liquid electrolytes. ASSBs include a solid electrolyte (SE) and the SE layer is usually made of inorganic oxide or sulfide electrolyte and used as substitute for the conventional liquid electrolyte interposed between cathode and anode. The SE layer functions as both electrolyte and separator, which allows transportation or flow of ions and prevents electronic contact between cathode and anode.

The general requirements for a solid electrolyte (SE) layer include: a) high ionic conductivity, b) good chemical/electrochemical stability against oxidation or reduction from its original phase, and c) physical/mechanical strength to prevent cathode and anode from direct or electronic contact, which usually results in catastrophic heat dissipation and fire or explosion.

Thiophosphate-based solid electrolytes (SEs) are promising because of their high ionic conductivities. The sulfide solid electrolyte membrane is usually prepared via a wet method including a solvent, which generally requires a scaffold layer as a mechanical support. Without the mechanical support layer, it has been impractical to prepare a sulfide electrolyte membrane. In one embodiment, the scaffold layer is a porous fabric which is usually made of a polymeric material such as polyester. The presence of the scaffold layer in a sulfide solid electrolyte membrane may impact the ion flux, decrease ionic conductivity and deteriorate the overall performance of the battery.

A solvent-free method (alternatively dry method) can be used to prepare a free-standing solid electrolyte. However, the solvent-free method is less capable of controlling the thickness uniformity and achieving a thickness of less than 50-100 μm. A fibrillization method is a typical solvent-free method using a fibrillizable binder such as polytetrafluoroethylene (PTFE), which requires a heated grinding or mixing to have the binder dispersed within solid components.

There remains a need for sulfide solid electrolyte membranes without scaffold or mechanical support layer while also maintaining suitable ion conductivity.

### SUMMARY

This disclosure provides a membrane of sulfide solid electrolyte without any scaffold or mechanical support layer (free-standing electrolyte membrane, or free-standing sulfide electrolyte membrane). In one embodiment, the sulfide solid electrolyte is an argyrodite. In one embodiment, the free-standing sulfide electrolyte exhibits an improved lithium-ion conductivity in comparison to the one with a scaffold layer. In one embodiment, an all solid-state battery comprising the free-standing sulfide electrolyte exhibits an improved cycling performance including stability and capacity retention rate.

### Definitions and Abbreviations

The following terms shall be used to describe the present disclosure. In the absence of a specific definition set forth herein, the terms used to describe the present disclosure shall be given their common meaning as understood by those of ordinary skill in the art.

A free-standing membrane (or alternatively a free-standing electrolyte membrane of free-standing sulfide electrolyte membrane) refers to a membrane that does not contain a scaffold layer and can be peeled from a base after formation without cracking or breaking.

A scaffold layer refers to a mechanical support layer that is impregnated with an electrolyte. An example of a scaffold layer includes a non-woven substrate with self-supporting property, which is capable of physically sustaining its own membranes without a scaffold layer, which may be a porous substrate.

In some embodiments, scaffold layer is alternatively referred as mechanical support layer, mechanical scaffold layer, or support layer.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows a schematic view of an all-solid state battery (ASSB) comprising a conventional sulfide electrolyte layer with a scaffold layer according to prior art.

FIG. 2 shows a schematic view of an ASSB comprising a free-standing sulfide electrolyte layer without any mechanical support layer according to one embodiment of the present disclosure.

FIG. 3 shows an SEM image of a cross-section of a solid electrolyte layer with a mechanical support layer.

FIG. 4 shows an SEM image of a cross-section of a solid electrolyte layer without a mechanical support layer.

FIG. 5 shows XRD patterns of representative solid electrolyte powders according to some embodiments of the present disclosure.

FIG. 6 shows conductivities of sulfide electrolyte powder, and sulfide electrolyte membranes with and without mechanical support layers according to some embodiments of the present disclosure.

FIG. 7A shows the cycling stability of cells according to some embodiments of the present disclosure.

FIG. 7B shows the capacity retention of cells of cells in a cycling test according to some embodiments of the present disclosure.

FIG. 7C shows the cycling stability of cells according to some embodiments of the present disclosure.

FIG. 7D shows the capacity retention of cells of cells in a cycling test according to some embodiments of the present disclosure.

FIG. 8A through 8C show the coulombic efficiency of cells in a cycling test according to some embodiments of the present disclosure.

### DETAILED DESCRIPTION

In one embodiment, the present disclosure provides a sulfide solid electrolyte membrane without a scaffold layer.

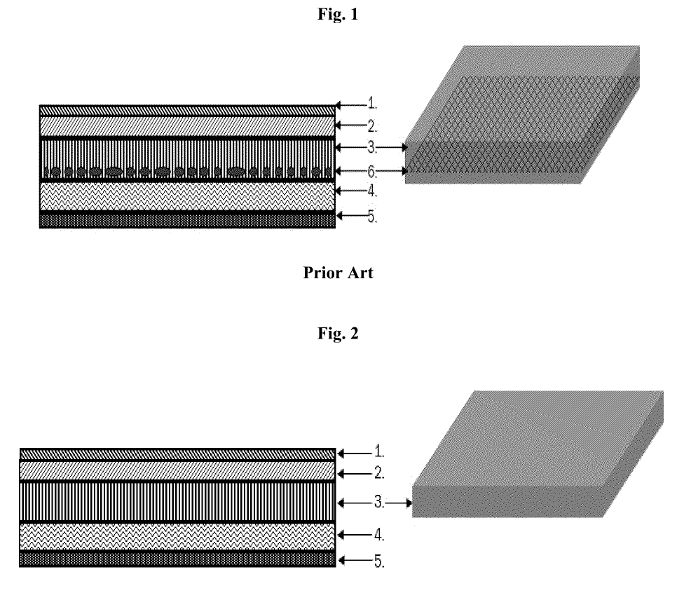

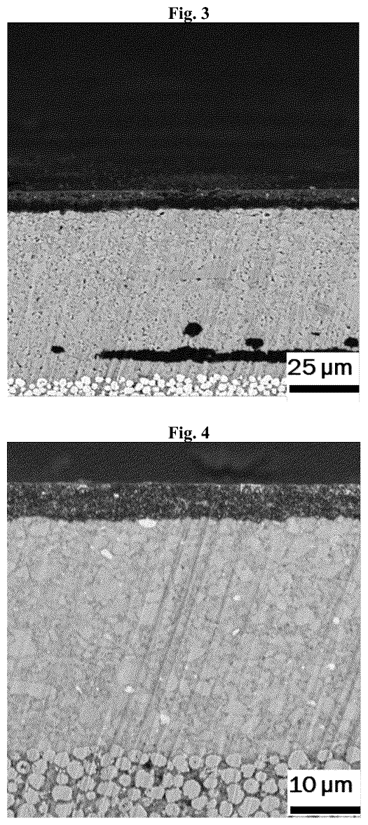

A cross-sectional view of a conventional ASSB according to prior art is shown in FIG. 1. Such conventional ASSB comprises a first electrode current collector (1), a first electrode (2), a solid electrolyte (3) comprising or attached to a scaffold layer (6) (such as a non-woven fabric), a second electrode (4), and a second electrode current collector (5). The first electrode can be either anode or cathode. The second electrode can be either the cathode or anode. The existence of the scaffold layer in the electrolyte impacts the ion flux, decreases ionic conductivity, and deteriorates the overall performance of the battery.

To address at least one of the challenges as described here, the present disclosure provides a solid electrolyte membrane free of a scaffold layer. FIG. 2 shows an ASSB comprising a solid electrolyte (3) that does not include and is not attached to any scaffold layer. Such membranes have a sufficient amount of non-fibrillizable binder to allow the membrane to be free-standing while also maintaining a suitable lithium-ion conductivity.

In one embodiment, the sulfide solid electrolyte in the electrolyte membrane is a compound represented by Formula I and having an argyrodite-type crystal structure: LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6−a−b−q<6, 0<1−p<1, and wherein M1 is at least one element of Group 1 or Group 11 other than H or Li of the periodic table, M2 is at least one element of Group 2 of the periodic table, and M3 is at least one element of Group 14 of the periodic table. In some embodiments, M1 is at least one selected from the group consisting of Na, K, Rb, Cs, Cu, Ag, and Au. In some embodiments, M2 is at least one selected from the group consisting of Be, Mg, Ca, Sr, and Ba. In some embodiments, M3 is at least one selected from the group consisting of Si, Ge, Sn, and Pb.

In one embodiment, the sulfide electrolyte in the free-standing electrolyte membrane as disclosed in the present disclosure has a cubic crystal structure. In one embodiment, the electrolyte has a crystal structure in the F^{4̅}3m space group as verified by XRD.

In one embodiment, the present disclosure provides a free-standing electrolyte membrane of sulfide solid electrolyte with a formula of LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6−a−b−q<6, 0<1−p≤1, and wherein 0≤b/a≤20.

In one embodiment, the free-standing electrolyte membrane has a thickness in a range from 5 μm to 300 μm, from 10 μm to 300 μm, from 20 μm to 300 μm, from 50 μm to 300 μm, from 2 μm to 500 μm, from 5 μm to 500 μm, from 10 μm to 500 μm, from 10 μm to 500 μm, from 20 μm to 500 μm, from 50 μm to 500 μm, or any and all ranges and subranges therebetween.

In some embodiments, the electrolyte membrane as disclosed herein has a lithium-ion conductivity which is at least 10%, at least 15%, at least 20%, at least 25%, at least 30%, at least 35%, at least 40%, at least 45%, or at least 50% of the intrinsic lithium-ion conductivity of the sulfide electrolyte powder. In some embodiments, the intrinsic lithium-ion conductivity of the sulfide electrolyte powder is equal to or higher than 1 mS/cm, 2.5 mS/cm, 5 mS/cm, 10 mS/cm, 15 mS/cm, 20 mS/cm, 30 mS/cm, or 40 mS/cm at room temperature.

In some embodiments, the electrolyte membranes as disclosed herein has a lithium-ion conductivity of at least 30% higher, at least 40% higher, at least 50% higher, at least 60% higher, at least 70% higher, at least 80% higher, at least 90% higher, or at least 100% higher than that of the electrolyte membranes prepared with scaffold layers. In some embodiments, the electrolyte membrane has a lithium-ion conductivity of no less than 0.05 mS/cm, no less than 0.1 mS/cm, no less than 0.2 mS/cm, no less than 0.5 mS/cm, no less than 0.75 mS/cm, no less than 1 mS/cm, no less than 2 mS/cm, or no less than 5 mS/cm, no less than 7.5 mS/cm or no less than 10 mS/cm. In sone embodiments, the free-standing electrolyte membrane has a lithium-ion conductivity in a range from 0.05 mS/cm to 10 mS/cm, from 0.1 mS/cm to 10 mS/cm, from 0.25 mS/cm to 10 mS/cm, from 0.5 mS/cm to 10 mS/cm, from 0.75 mS/cm to 10 mS/cm, from 1 mS/cm to 10 mS/cm, from 2 mS/cm to 10 mS/cm, from 0.05 mS/cm to 7.5 mS/cm, from 0.1 mS/cm to 7.5 mS/cm, from 0.25 mS/cm to 7.5 mS/cm, from 0.5 mS/cm to 7.5 mS/cm, from 0.75 mS/cm to 7.5 mS/cm, from 1 mS/cm to 7.5 mS/cm, from 2 mS/cm to 7.5 mS/cm, from 0.05 mS/cm to 5 mS/cm, from 0.1 mS/cm to 5 mS/cm, from 0.25 mS/cm to 5 mS/cm, from 0.5 mS/cm to 5 mS/cm, from 0.75 mS/cm to 5 mS/cm, from 1 mS/cm to 5 mS/cm, or any and all ranges and subranges therebetween.

In one embodiment, the formula of sulfide solid electrolyte in the free-standing electrolyte membrane, i.e., LiₓM1_{y}M2_{z}P₁₋ₚM3ₚS_{6-a-b-q}O_{q}ClₐBr_{b}, does not comprise any of M1, M2, M3 or O, i.e., y=z=p=q=0, corresponding to a formula of LiₓPS_{6-a-b}ClₐBr_{b}.

In one embodiment, the formula of the sulfide electrolyte comprises at least one element selected from the group consisting of M1, M2, M3 and O. In some embodiments, the Formula (I) contains one element selected from the group consisting of M1, M2, M3 and O. In some embodiments, Formula I is selected from the group consisting of:
1) LiₓM1_{y}PS_{6-a-b}ClₐBr_{b}, where 4≤x≤8, 0<y<1, 0≤a≤2, 0≤b<2, 0<6−a−b<6;
2) LiₓM2_{z}PS_{6-a-b}ClₐBr_{b}, where 4≤x≤8, 0<z≤1, 0≤a≤2, 0≤b<2, 0<6−a−b<6;
3) LiₓP₁₋ₚM3ₚS_{6-a-b}ClₐBr_{b}, where 4<x<8, 0<p≤1, 0≤a≤2, 0≤b<2, 0<6−a−b<6, 0<1−p<1; and
4) LiₓPS_{6-a-b-q}O_{q}ClₐBr_{b}, where 4≤x≤8, 0<q≤1, 0≤a≤2, 0≤b<2, 0<6−a−b−q<6.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<10≤q<1, 0≤a≤2, 0≤b<2, 0<6−a−b−q<6), LiₓM2_{Z}P₁S_{6-a-b-q}O_{q}ClₐBr_{b} (4≤x≤8, 0<z<1, 0≤q<1, 0<a≤2, 0≤b<2, 0<6−a−b−q<6,), and LiₓP₁₋ₚM3ₚS_{6-a-b-q}O_{q}CLₐBr_{b} (4≤x≤8, 0<p<1, 0≤q≤1, 0≤a≤2, 0≤b <2, 0≤6−a−b−q<6, 0<1−p<1). In one embodiment, the Formula (I) contains O without M1, M2, or M3. In one embodiment, the formula of the sulfide electrolyte is LiₓPS_{6-a-b-q}O_{q}ClₐBr_{b} (4≤x≤8, 0<q<1, 0≤a≤2, 0≤b<2, 0<6−a−b−q<6). In some embodiments, M1 is at least one element of Group 1 or Group 11 other than H or Li of the periodic table. In some embodiments, M1 is at least one selected from the group consisting of Na, K, Rb, Cs, Cu, Ag, and Au. In some embodiments, M2 is at least one element of Group 2 of the periodic table. In some embodiments, M2 is at least one selected from the group consisting of Be, Mg, Ca, Sr, and Ba. In some embodiments, M3 is at least one element of Group 14 of the periodic table. In some embodiments, M3 is at least one selected from the group consisting of Si, Ge, Sn, and Pb.

In one embodiment, the sulfide solid electrolyte has a formula of LiₓPS_{6-a-b-q}O_{q}ClₐBr_{b}, where 4≤x≤8, 0<q≤1, 0≤a≤2, 0≤b<2, 0<6−a−b−q<6. The incorporation of oxygen into the formula makes such material more stable. In some embodiments, the molar amount of O with q having a value in a range from 0 to 0.1, from 0 to 0.2, from 0 to 0.3, from 0 to 0.4, from 0 to 0.5, from 0 to 0.6, from 0.001 to 0.1, from 0.001 to 0.2, from 0.001 to 0.3, from 0.001 to 0.4, from 0.001 to 0.5, from 0.001 to 0.6, from 0.002 to 0.1, from 0.002 to 0.2, from 0.002 to 0.3, from 0.002 to 0.4, from 0.002 to 0.5, from 0.002 to 0.6, from 0.005 to 0.1, from 0.005 to 0.2, from 0.005 to 0.3, from 0.005 to 0.4, from 0.005 to 0.5, from 0.005 to 0.6, or any and all ranges and subranges therebetween. In one embodiment, the formula is Li_{5.8}PS_{4.7}O_{0.1}Cl_{1.2}.

In one embodiment, the formula is LiₓPS_{6-a-b-q}O_{q}ClₐBr_{b}, wherein 4≤x≤8, 0<q≤1, 0≤a≤2, 0<b<2, 0<6−a−b−q<6. In some embodiments, b/a has a value higher than zero. In some embodiments, b/a has a value in a range from 0 to 3.5. In some embodiments, b/a has a value in a range from 0 to 7. In some embodiments, b/a has a value in a range from 0 to 10, from 0to 15, or from 0 to 20.

In one embodiment, when the formula is LiₓM1_{y}PS_{6-a-b-q}ClₐBr_{b}, 4≤x≤8, 0<y<1, 0≤a≤2, 0≤b<2, 0<6−a−b<6, b/a has a value in a range from 0 to 3.5. In some embodiments, b/a has a value in a range from 0 to 7. In some embodiments, b/a has a value in a range from 0 to 10,from 0 to 15, or from 0 to 20. In some embodiments, b/a has a value higher than zero.

In one embodiment, when the formula is LiₓM2_{z}PS_{6-a-b}ClₐBr_{b}, where 4≤x≤8, 0<z≤1, 0≤a≤2, 0≤b<2, 0<6−a−b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In one embodiment, when the formula is LiₓP₁₋ₚM3ₚS_{6-a-b}ClₐBr_{b}, 4≤x≤8, 0<p≤1, 0≤a≤2, 0≤b<2, 0<6−a−b<6, 0<1−p<1, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<1, 0<q<1, 0≤a≤2, 0≤b<2, 0<6−a−b−q<6), LiₓM2_{z}PS_{6-a-b-q}O_{q}ClₐBr_{b} (4≤x≤8, 0 <z<1, 0≤q<1, 0≤a≤2, 0≤b<2, 0<6−a−b−q<6,), and LiₓP₁₋ₚM3ₚS_{6-a-b-q}O_{q}ClₐBr_{b} (4≤x≤8, 0<p<1, 0<q<1, 0≤a≤2, 0≤b<2, 0<6−a−b−q<6, 0<1−p<1). In one embodiment, the Formula (I) contains O without M1, M2, or M3. In one embodiment, the formula of the sulfide electrolyte is LiₓPS_{6-a-b-q}O_{q}ClₐBr_{b} (4≤x≤8, 0<q<1, 0≤a≤2, 0≤b<2, 0<6−a−b−q<6). In some embodiments, the molar amount of Br in the formula has a value higher than zero, i.e., b>0.

In one embodiment, the total molar amount of the halogen in the formula of sulfide electrolyte is no more than 2, i.e., a+b≤2. In one embodiment, the total molar amount of the halogen in the formula is no less than 2 and no more than 3, i.e., 2≤a+b≤3. In one embodiment, the total molar amount of the halogen in the formula is no less than 2 and less than 4, i.e., 2≤a+b<4. In one embodiment, the total molar amount of Br and Cl in the formula is no more than 2, i.e., a+b≤2, no less than 2 and no more than 3, i.e., 2≤a+b≤3, or no less than 2 and less than 4, i.e., 2≤a+b<4.

In one embodiment, the sulfide solid electrolyte has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8}Br_{0.4}, Li_{5.8}PS_{4.8}Cl_{1.0}Br_{0.2}, and Li_{5.4}PS_{4.4}Cl_{1.4}Br_{0.2}.

In some embodiments, the free-standing SE membrane comprises a nonfibrillizable binder with a weight percentage of no less than 0.5 wt %, no less than 0.75 wt %, no less than 1.0 wt %, no less than 1.25 wt %, no less than 1.5 wt %, or no less than 2.0 wt % to ensure the SE membrane can be peeled or detached from the base during preparation without cracking or being damaged. In some embodiments, the free-standing SE membrane comprises a nonfibrillizable binder with a weight percentage of no higher than 3.5%, no higher than 5 wt %, no higher than 7.5 wt %, no higher than 10 wt %, or no higher than 12.5 wt % so that the SE membrane has a desirable ionic conductivity. In some embodiments, the free-standing SE membrane comprises a nonfibrillizable binder with a percentage in a range from 0.5 wt % to 5 wt %, from 0.5 wt % to 7.5 wt %, from 0.5 wt % to 10 wt %, from 0.75 wt % to 5 wt %, from 0.75 wt % to 7.5 wt %, from 0.75 wt % to 10 wt %, from 1.0 wt % to 5 wt %, from 1.0 wt % to 7.5 wt %, from 1.0 wt % to 10 wt %, from 1.25 wt % to 5 wt %, from 1.25 wt % to 7.5 wt %, from 1.25 wt % to 10 wt %, from 1.5 wt % to 5 wt %, from 1.5 wt % to 7.5 wt %, from 1.5 wt % to 10 wt %, from 2.0 wt % to 5 wt %, from 2.0 wt % to 7.5 wt %, from 2.0 wt % to 10 wt %, or any ranges and subranges therebetween.

In some embodiments, the amount of binder is chosen so that the lithium-ion conductivity is in a suitable range. For example, the free-standing solid electrolytes can have (i) a nonfibrillizable binder with a percentage in a range from 0.5 wt % to 5 wt %, from 0.5 wt % to 7.5 wt %, from 0.5 wt % to 10 wt %, from 0.75 wt % to 5 wt %, from 0.75 wt % to 7.5 wt %, from 0.75 wt % to 10 wt %, from 1.0 wt % to 5 wt %, from 1.0 wt % to 7.5 wt %, from 1.0 wt % to 10 wt %, from 1.25 wt % to 5 wt %, from 1.25 wt % to 7.5 wt %, from 1.25 wt % to 10 wt %, from 1.5 wt % to 5 wt %, from 1.5 wt % to 7.5 wt %, from 1.5 wt % to 10 wt %, from 2.0 wt % to 5 wt %, from 2.0wt % to 7.5 wt %, from 2.0 wt % to 10 wt %, or any ranges and subranges therebetween and/or (ii) a lithium-ion conductivity which is at least 10%, at least 15%, at least 20%, at least 25%, at least 30%, at least 35%, at least 40%, at least 45%, or at least 50% of the intrinsic lithium-ion conductivity of the sulfide electrolyte powder and/or (iii) a lithium-ion conductivity of at least 30% higher, at least 40% higher, at least 50% higher, at least 60% higher, at least 70% higher, at least 80% higher, at least 90% higher, or at least 100% higher than that of an electrolyte membranes having the same binder and sulfide solid electrolyte but prepared with a scaffold layer.

In one aspect, the present disclosure provides an all solid-state battery (ASSB) comprising the free-standing electrolyte membrane as disclosed herein.

In some embodiments, the ASSB comprising a free-standing SE membrane as disclosed herein exhibits a capacity retention rate of no less than 90.0%, 91.0%, 92.0%, 93.0% or 94.0% after at least 100 cycles at a rate of C/3 at room temperature. In some embodiments, the ASSB comprising a free-standing SE membrane as disclosed herein exhibits a capacity retention rate of no less than 85%, 87.5%, 89%, 90.0%, 91%, or 92% after at least 300 cycles at a rate of C/3at room temperature. In some embodiments, the cycling test can be performed at other C rates such as C/6, C/4, C/2, C, 1C, 2C, 3C, 5C, or any intermediate rate therebetween. In some embodiments, the cycling test can be performed at other temperatures such as −20° C.,−10° C., 0° C., 10° C., 25° C., 30° C., 4020 C., 50° C., 80° C., or any intermediate temperature therebetween. Cycle life is determined by the number of cycles for the battery cell to reach a threshold value (for example, 80%, 85% or 90%) of its original capacity and is usually used to measure the cycling performance of a secondary battery. In some embodiments, the ASSB comprising a free-standing SE membrane exhibits a cycle life which is at least 5%, at least 7.5%, at least 10%, at least 15%, at least 20%, at least 25%, at least 30%, at least 40%, at least 50%, at least 60%, at least 70%, at least 100%, at least 150%, at least 200% or at least 300% longer than that of the ones with an SE comprising a scaffold layer.

In one embodiment, the ASSB further comprises a cathode comprising a cathode active material. In some embodiments, the ASSB has a relatively high cathode loading. In some embodiments, the ASSB has a cathode loading of at least 5.0 mAh/cm², at least 5.5 mAh/cm², at least 6.0 mAh/cm², at least 6.5 mAh/cm², at least 6.8 mAh/cm², at least 7.2 mAh/cm², or at least 7.5 mAh/cm². A high cathode loading is critical to achieve a high energy density. However, a battery with a high cathode loading may be subject to a relatively fast decay, which ultimately leads to a lower capacity retention. In some embodiments, the present disclosure provides an ASSB having both a high cathode loading and a good cycling performance.

In some embodiments, the ASSB comprising a free-standing SE membrane as disclosed herein exhibits one or more characteristics selected from the group consisting of:
a. an initial specific capacity of at least 160.0 mAh/g, at least 170.0 mAh/g, at least 180.0 mAh/g, at least 185.0 mAh/g or at least 190.0 mAh/g at a rate of C/3 at room temperature,
b. a specific capacity of at least 155 mAh/g, at least 165 mAh/g, at least 175 mAh/g or at least 180 mAh/g after 100 cycles at a rate of C/3 at room temperature,
c. a specific capacity of at least 150 mAh/g, at least 160 mAh/g, at least 170 mAh/g or at least 175 mAh/g after 300 cycles at a rate of C/3 at room temperature,
d. a specific capacity of at least 145 mAh/g, at least 155 mAh/g, at least 165 mAh/g or at least 170 mAh/g after 400 cycles at a rate of C/3 at room temperature,
e. a capacity retention rate of at least 91.0%, at least 91.5%, at least 92.0% at least 92.5% or at least 93.0% after 100 cycles at a rate of C/3 at room temperature,
f. a capacity retention rate of at least 90.50%, at least 91.0%, at least 91.5%, at least 92.0% or at least 92.5% after 300 cycles at a rate of C/3 at room temperature, and
g. a capacity retention rate of at least 88.5%, at least 89.0%, at least 89.5% at least 90.0% or at least 90.5% after 400 cycles at a rate of C/3 at room temperature.

In one embodiment, the cathode active material shows a redox reaction at a potential of 2 V or more on a lithium electrode basis during operation of the all solid-state battery.

In one embodiment, the cathode active material contains Li, Ni, and Co. In one embodiment, the cathode active material contains Li, Ni, and Co and at least one of Mn and Al.

In one embodiment, the cathode active material contains at least one of Fe, and P.

In one embodiment, the ASSB further comprises a positive electrode layer containing a positive electrode active substance and negative electrode layer, wherein the free-standing electrolyte membrane is arranged between the positive electrode layer and the negative electrode layer.

In one embodiment, the negative electrode layer comprises particles of a carbon-based conductive material with at least one selected from the group consisting of carbon black, acetylene black, Ketjen black, channel black, furnace black, lamp black, thermal black, natural graphite and artificial graphite.

In one embodiment, the negative electrode layer comprises a metal with at least one selected from the group consisting of lithium, sodium, magnesium, aluminum, silicon, calcium, titanium, manganese, iron, cobalt, nickel, zinc, molybdenum, silver, indium, tin, and tungsten.

In one aspect, the present disclosure provides a method for preparing a free-standing sulfide solid electrolyte via a slurry method. In one embodiment, the method may comprise:
1) mixing particles of the sulfide electrolyte with Formula (I), a binder, and solvent resulting in a slurry;
2) coating the slurry on a base followed by a vacuum drying at room temperature, wherein the base comprising a film, leading to a dried coating on the base; and
3) peeling the dried coating from the base, thereby obtaining an electrolyte membrane.

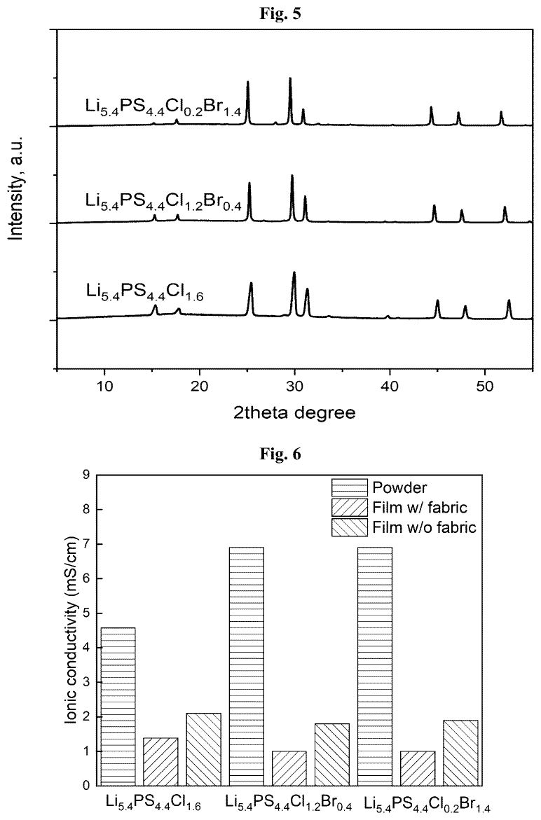

In one embodiment, the particles of the sulfide electrolyte are prepared by mixing raw precursor powders at a stoichiometric ratio in an inert atmosphere, followed by sintering at 400-700° C. for 4-24 hours and grinding. In some embodiments, the raw precursor powders comprise Li₂S, Na₂S, P₂S₅, LiCl, LiBr, Li₂O, and GeS₂. In some embodiments, the particles of the sulfide electrolyte have a cubic crystal structure. In one embodiment, the particles of the sulfide electrolyte have a crystal structure in the F^{4̅}3m space group as verified by XRD as shown in FIG. 5.

In one embodiment, the nonfibrillizable binder for the wet method may be a non-aqueous acrylate-type binder, a rubber-type binder such as styrene-butadiene rubber (SBR), poly(vinylidene fluoride) (PVDF), polyethylene (PE), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, polyarylate, cellulose acetate, cellulose acetate butyrate, cellulose acetate propionate, polysaccharide polymer and carboxyl methyl cellulose, or a combination thereof.

In one embodiment, the solvent comprises xylene, isobutyl isobutyrate or a mixture thereof.

In one embodiment, the slurry comprises a solvent with a weight percentage in a range from 20% to 70%, from 20% to 65%, from 20% to 60%, from 20% to 55%, from 20% to 50%, from 20% to 45%, from 25% to 70%, from 25% to 65%, from 25% to 60%, from 25% to 55%, from 25% to 50%, from 25% to 45%, from 30% to 70%, from 30% to 65%, from 30% to 60%, from 30% to 55%, from 30% to 50%, from 30% to 45%, from 35% to 70%, from 35% to 65%, from 35% to 60%, from 35% to 55%, from 35% to 50%, from 35% to 45%, from 40% to 70%, from 40% to 65%, from 40% to 60%, from 40% to 55%, from 40% to 50%, from 40% to 45%, or any and all ranges and subranges therebetween.

In one embodiment, the particles of the SE material, the binder and the solvent are mixed in a planetary centrifugal mixer.

In one embodiment, the base is a film. In one embodiment, the film is non-stick and chemical resistant. In one embodiment, the film is peelable or detachable from the dried SE coating or membrane. In one embodiment, the film comprises polyethylene terephthalate (PET), fluorinated ethylene propylene (FEP) copolymer, perfluoroalkoxy (PFA) polymer, ethylene tetrafluoroethylene (ETFE) copolymer, or a mixture thereof. In one embodiment, the film does not have porous structure. In one embodiment, the film further comprises a silicone coating, forming a coated film such as PET film coated with silicone. In one embodiment, the film is an FEP film, a PFA film, or an ETFE film. In some embodiments, the non-stick film has a thickness around 7.5 μm, around 10 μm, around 12 μm, around 15 μm, around 20 μm, around 25 μm, around 50 μm, around 75 μm, around 100 μm, around 150 μm, around 200 μm, around 250 μm, or around 500 μm. In the comparative examples, the base comprises a film and a non-woven fabric layer. In some embodiments, the non-woven fabric functions as a scaffold layer or a mechanical support layer, which is usually required by a wet method for preparing an SE membrane. In one embodiment, the non-woven fabric is made of a polyester such as PET.

The disclosure will be better understood by reference to the Experimental Details which follow, but those skilled in the art will readily appreciate that the specific experiments detailed are only illustrative and are not meant to limit the disclosure as described herein, which is defined by the claims which follow thereafter.

It is to be noted that the transitional term “comprising”, which is synonymous with “including”, “containing” or “characterized by”, is inclusive or open-ended and does not exclude additional, un-recited elements or method steps.

### EXAMPLE

### Synthesis of Solid Electrolyte Materials

In a glove box having an inert Ar atmosphere, raw precursor powders were prepared at a stoichiometric ratio. The precursor examples include, but are not limited to, Li₂S, Na₂S, P₂S₅, LiCl, LiBr, Li₂O. GeS₂, or combinations thereof. These powders were ball milled planetary ball miller for 4 hours. Subsequently, these powders were sintered at 450° C. for 12 hours.

Thereby, solid electrolyte materials with argyrodite-type structure were obtained. After a grinding procedure, solid electrolyte particles have an average particle size in a range from 1 to 10 μm and will be used for slurry preparation.

### Preparation of Solid Electrolyte Membrane

A free-standing sulfide solid electrolyte membrane was prepared via a slurry method. First, particles of the above sulfide electrolyte were mixed with an acrylate type binder and a solvent, resulting in a slurry. Second, the slurry was applied to a base followed by a vacuum drying at room temperature, leading to a dried coating on the base. A free-standing solid electrolyte (SE) membrane was obtained by peeling the dried coating from the base. The binder content is critically important in achieving the free-standing SE membrane and balancing the overall performance. A binder content lower than 1.0 wt % would not be able to get a free-standing membrane and a binder content higher than 10 wt % leads to a much-deteriorated ionic conductivity.

Comparative SE membranes were prepared by following the method above except that a base comprising a PET film and a non-woven fabric support layer as a scaffold layer was used. The slurry was coated on the non-woven fabric and impregnated the pores of the non-woven fabric.

### Assembly of Cells and Testing

A cell comprising a cathode (85 wt % CAM) with a cathode loading of around 6.8 mAh/cm², an anode, and an SE membrane as prepared above was assembled and sealed in a pouch followed by an isostatic pressing.

### Characterizations and Tests of Solid Electrolyte Membrane

TABLE 1
Lithium-ion conductivity retention ratio in comparison to powder

| | | % Li-ion | % increase |
|---|---|---|---|
| | % Li-ion | conductivity | in Li-ion |
| | conductivity | without | conductivity |
| | with fabric | fabric | by not |
| | compared | compared | including |
| Powder | to powder | to powder | fabric |
| Li_{5.4}PS_{4.4}Cl_{1.6} | 30% | 45% | 50% |
| Li_{5.4}PS_{4.4}Cl_{1.2}Br_{0.4} | 14% | 26% | 86% |
| Li_{5.4}PS_{4.4}Cl_{0.2}Br_{1.4} | 14% | 27% | 93% |

X-ray diffraction (XRD) measurement was performed using an X-ray diffractometer (SmartLab, Rigaku) with Cu—Kα radiation. Diffraction data were collected in steps of 0.05° over a 2θ range of 5-60° at a scan rate of 3° min⁻¹. XRD measurements were performed using an airtight container to prevent air exposure to the electrolyte powder. For the measurement of lithium-ion conductivity: SE membranes were first punched into a disc with diameter of 1.2 cm, and pressed in a torque cell (PEEK) with stacking pressure of 375 MPa. Titanium plungers were used as current collectors. Ionic conductivities of solid electrolyte membrane were measured by electrochemical impedance spectroscopy (EIS) were collected in the range from 1 Hz to 7 MHz using a potentiostat (SP200, Biologic) with an applied AC voltage of 10 mV. All measurements were performed at room temperature unless otherwise specified.

TABLE 2
Electrochemical performance of cells comprising free-standing
SE membranes or comparative SE membranes

| | | | Retention | Specific |
|---|---|---|---|---|
| | | | at end of | capacity at |
| | | No. of | No. of | end of No. of |
| Examples | SE material | Cycles | cycles (%) | cycles (mAh/g) |
| Example 1 | Li_{5.4}PS_{4.4}Cl_{1.2}Br_{0.4} | 370 | 94.3 | 176.9 |
| Example 2 | Li_{5.4}PS_{4.4}Cl_{0.2}Br_{1.4} | 379 | 91.9 | 170.7 |
| Comparative | Li_{5.4}PS_{4.4}Cl_{1.6} | 239 | 93.0 | 176.4 |
| Example 1 * | | | | |
| Comparative | Li_{5.4}PS_{4.4}Cl_{1.6} | 248 | 80.0 | 147.5 |
| Example 2 * | | | | |

* Comparative examples 1-2 were prepared with a scaffold layer.

TABLE 2-1
Electrochemical performance of cells comprising free-standing
SE membranes or comparative SE membranes

| | | | Retention | Specific |
|---|---|---|---|---|
| | | | at end of | capacity at |
| | | No. of | no. of | end of no. of |
| Examples | SE material | Cycles | cycles (%) | cycles (mAh/g) |
| Example 1 | Li_{5.4}PS_{4.4}Cl_{1.2}Br_{0.4} | 1169 | 86.8 | 162.8 |
| Example 2 | Li_{5.4}PS_{4.4}Cl_{0.2}Br_{1.4} | 1189 | 84.1 | 156.1 |
| Comparative | Li_{5.4}PS_{4.4}Cl_{1.6} | 436 | 78.9 | 149.6 |
| Example 1 * | | | | |
| Comparative | Li_{5.4}PS_{4.4}Cl_{1.6} | 507 | 66.5 | 103.5 |
| Example 2 * | | | | |
| Comparative | Li_{5.4}PS_{4.4}Cl_{1.2}Br_{0.4} | 469 | 77.3 | 143.0 |
| Example 3 * | | | | |
| Comparative | Li_{5.4}PS_{4.4}Cl_{0.2}Br_{1.4} | 422 | 88.6 | 162.9 |
| Example 4 * | | | | |

* Comparative examples 1-4 were prepared with a scaffold layer.

As shown in FIG. 6 and Table 1, the free-standing electrolyte membrane as prepared herein has an improved lithium-ion conductivity in comparison with that of those prepared with a mechanical support or scaffold layer. As for sulfide electrolyte with a formula of Li_{5.4}PS_{4.4}Cl_{1.6}, the free-standing electrolyte membrane and the conventional electrolyte membrane with a non-woven fabric as a scaffold layer exhibit a lithium-ion conductivity of 2.06 mS/cm and 1.37 mS/cm, respectively. The ionic conductivity of the free-standing electrolyte membrane is 50% higher than that of the one prepared with a non-woven fabric. As for sulfide electrolyte with a formula of Li_{5.4}PS_{4.4}C_{1.2}Br_{0.4}, a free-standing electrolyte membrane and a conventional electrolyte membrane with a non-woven fabric as a scaffold layer exhibit a lithium-ion conductivity of 1.80 mS/cm and 0.97 mS/cm, respectively. The ionic conductivity of the free-standing electrolyte membrane is 86% higher than that of the one prepared with a non-woven fabric. As for sulfide electrolyte with a formula of Li_{5.4}PS_{4.4}Cl_{0.2}Br_{1.4}, a free-standing electrolyte membrane and a conventional electrolyte membrane with a non-woven fabric as a scaffold layer exhibit a lithium-ion conductivity of 1.86 mS/cm and 0.97 mS/cm, respectively. The ionic conductivity of the free-standing electrolyte membrane is 93% higher than that of the one prepared with a non-woven fabric.

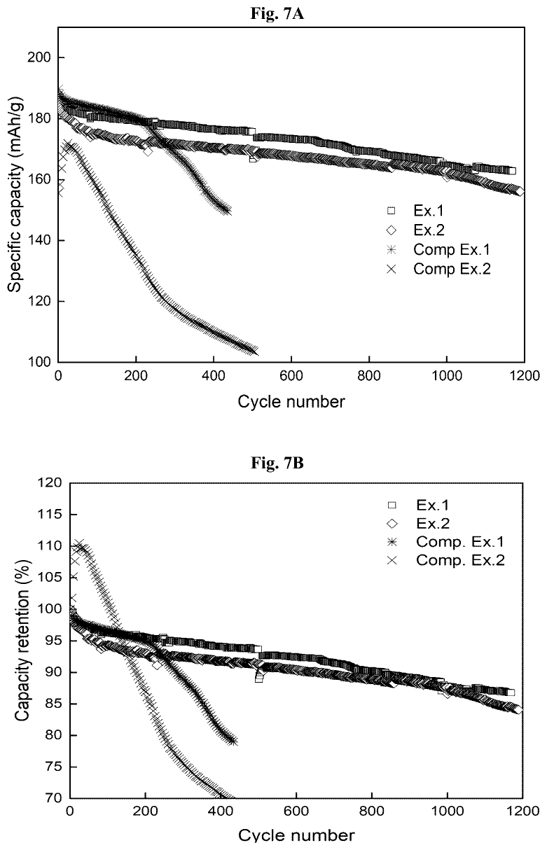

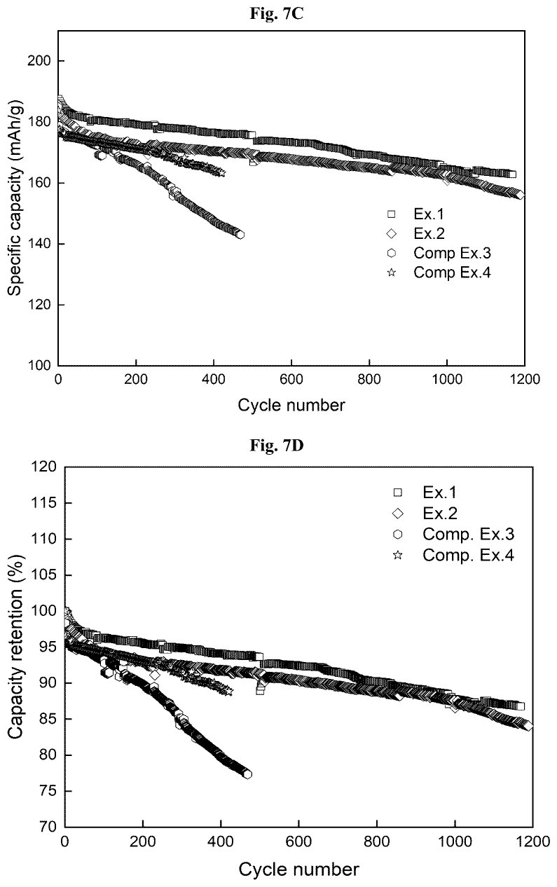

As shown in Tables 2 and 2-1, FIGS. 7A, 7B, 7C and 7D, the cells comprising a free-standing SE membrane of Li_{5.4}PS_{4.4}C_{1.2}Br_{0.4} (Example 1) and Li_{5.4}PS_{4.4}Cl_{0.2}Br_{1.4} (Example 2) exhibit a capacity retention rate of 86.8% and 84.1% after 1169 cycles and 1189 cycles, respectively. After more than 1000 cycles, it does not show any trend leading to a significant decay. Nor does it reach a retention rate of 80% soon. The cells comprising the comparative examples 1-4 exhibit a less desirable cycling performance, i.e., a capacity retention rate of 78.9%, 66.5%, 77.3%, and 88.6% after 436, 507, 469, and 422 cycles, respectively. The results clearly demonstrated that the free-standing solid electrolyte (SE) exhibits a significantly improved cycling performance.

TABLE 3
Cycling performance of cells in view of specific capacity

| | Initial | | | | |
|---|---|---|---|---|---|
| | specific | Specific capacity (mAh/g) | | | |
| | capacity | after 100 | after 200 | after 300 | after 400 |
| | (mAh/g) | cycles | cycles | cycles | cycles |
| Example 1 | 187.6 | 180.7 | 179.2 | 178.0 | 176.5 |
| Example 2 | 185.6 | 175.1 | 172.8 | 171.6 | 170.5 |
| Comparative | 189.7 | 183.3 | 180.1 | 168.6 | 153.1 |
| Example 1 | | | | | |
| Comparative | 155.6 | 157.2 | 135.2 | 117.5 | 109.8 |
| Example 2 | | | | | |
| Comparative | 185.0 | 172.4 | 166.2 | 156.9 | 147.3 |
| Example 3 | | | | | |
| Comparative | 183.8 | 173.2 | 171.1 | 167.9 | 164.3 |
| Example 4 | | | | | |

TABLE 4
Cycling performance of cells in view of retention rate

| | Retention rate (%) | | | |
|---|---|---|---|---|
| | after 100 | after 200 | after 300 | after 400 |
| | cycles | cycles | cycles | cycles |
| Example 1 | 96.3 | 95.6 | 94.9 | 94.1 |
| Example 2 | 94.3 | 93.1 | 92.4 | 91.8 |
| Comparative | 96.6 | 94.9 | 88.9 | 80.7 |
| Example 1 | | | | |
| Comparative | 101.0 | 86.9 | 75.5 | 70.6 |
| Example 2 | | | | |
| Comparative | 93.2 | 89.8 | 84.8 | 79.7 |
| Example 3 | | | | |
| Comparative | 94.3 | 93.1 | 91.3 | 89.4 |
| Example 4 | | | | |

Both specific capacity and retention rate are important metrics in evaluating the cycling performance of an electrochemical device such as a battery cell. It is challenging to achieve both parameters with a high value. Tables 3 and table 4 summarize the cycling performance in view of the specific capacity and retention rate, respectively. It can be seen that the cells comprising examples 1 and 2 and comparative examples 1-4 exhibited an initial specific capacity of 187.6 mAh/g, 185.6 mAh/g, 189.7 mAh/g, 155.6 mAh/g, 185.0 mAh/g, and 183.8 mAh/g, respectively. After 100 cycles, they changed to 180.7 mAh/g, 175.1 mAh/g, 183.3 mAh/g, 157.2 mAh/g, 172.4 mAh/g and 173.2mAh/g, respectively, leading to a capacity retention rate of 96.3%, 94.3%, 96.6%, 101.0%, 93.2% and 94.3%, respectively. After 200cycles, those specific capacities were reduced to 179.2 mAh/g, 172.8 mAh/g, 180.1 mAh/g, 135.2 mAh/g, 166.2 a mAh/g and 171.1 mAh/g, corresponding to a capacity retention rate of 95.6%, 93.1%, 94.9%, 86.9%, 89.8% and 93.1%, respectively. After 300 cycles, their capacities were reduced to 178.0 mAh/g, 171.6 mAh/g, 168.6 mAh/g, 117.5 mAh/g, 156.9 mAh/g and 167.9 mAh/g, corresponding to a capacity retention rate of 94.9%, 92.4%, 88.9%, 75.5%, 84.8% and 91.3%, respectively. After 400 cycles, their capacities were further reduced to 176.5 mAh/g, 170.5 mAh/g, 153.1 mAh/g, 109.8 mAh/g, 147.3 mAh/g and 164.3 mAh/g, corresponding to a capacity retention rate of 94.1%, 91.8%, 88.9%, 75.5%, 84.8% and 89.4%, respectively.

It is well known that a high cathode loading is critical to achieve a high energy density. However, a battery with a high cathode loading may be subject to a relatively fast decay, which ultimately leads to a lower capacity retention. In other words, a battery with a relatively low cathode loading has a relatively low initial specific capacity and may exhibit a high cycling performance. In some embodiments, the present disclosure provides a battery with a high cathode loading, for example, 6.8 mAh/cm² in the examples. In some embodiments, the battery comprising the free-standing solid electrolyte as disclosed herein exhibits an initial specific capacity of at least 180.0 mAh/g at a rate of C/3 at room temperature.

As shown in Tables 3 and 4, the battery comprising the free-standing solid electrolyte (examples 1 and 2) exhibits a specific capacity of at least 175.0 mAh/g after 100 cycles at a rate of C/3 at room temperature while comparative examples 3 and 4 are 172.4 and 173.2 mAh/g, respectively.

The battery comprising the free-standing solid electrolyte (examples 1 and 2) exhibits a specific capacity of 168.0 mAh/g or higher after 300 cycles at a rate of C/3 at room temperature while comparative examples 3 and 4 are lower than 168 mAh/g, i.e., 156.9 mAh/g and 167.9 mAh/g, respectively. In terms of the capacity retention rate, the battery comprising the free-standing solid electrolyte (examples 1 and 2) exhibits a retention rate of 94.9% and 92.4%, respectively. On the other hand, the comparative examples 3 and 4 exhibit a retention rate lower than 91.5%, i.e., 84.8% mAh/g and 91.3%, respectively.

The battery comprising the free-standing solid electrolyte (examples 1 and 2) exhibits a specific capacity of 165.0 mAh/g or higher after 400 cycles at a rate of C/3 at room temperature while the comparative examples 3 and 4 exhibit a specific capacity lower than 165mAh/g, i.e., 147.3 mAh/g and 164.3 mAh/g, respectively. In terms of the capacity retention rate, the battery comprising the free-standing solid electrolyte (examples 1 and 2) exhibits a retention rate of 94.1% and 91.8%, respectively. On the other hand, the comparative examples 3 and 4 exhibit a retention rate lower than 89.5%, i.e., 79.7% and 89.4%, respectively.

TABLE 5
Cycle life of cells comprising free-standing
SE membranes or comparative SE membranes

| | Cycle life, cycles ^{a} |
|---|---|
| Example 1 | 831 |
| Example 2 | 656 |
| Comparative Example 1 | 283 |
| Comparative Example 2 | 176 |
| Comparative Example 3 | 196 |
| Comparative Example 4 | 373 |

^{a} cycle life is determined by the number of cycles for the battery cell to reach 90% of its initial (or original) capacity.

Cycle life is determined by the number of cycles for the battery cell to reach a threshold value of its original capacity. As shown in Table 5, the cell with the free-standing SE of example 1 achieved a cycle life of 831 cycles at a rate of C/3 at room temperature. It is much higher than that of the comparative example 3, which was 196 cycles. The cycle life of the cell comprising example 1 is unexpectedly increased by more than 300% in comparison to that of the comparative example 3.

The cell with the free-standing SE of example 2 reached a cycle life of 656 cycles. It is significantly higher than that of the comparative example 4, which was 373 cycles. The cycle life of the cell comprising example 2 is significantly increased by more than 70% in comparison to the comparative example 4. In some embodiments, the cells comprising the free-standing SE membrane demonstrate a cycle life which is at least 10%, at least 20%, at least 40%, at least 70%, at least 100%, at least 150% or at least 300% longer than that of the ones comprising comparative SE membranes.

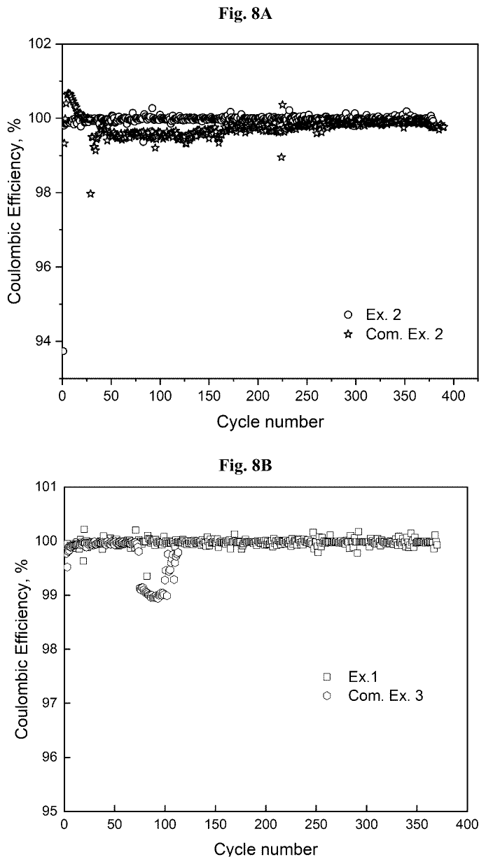

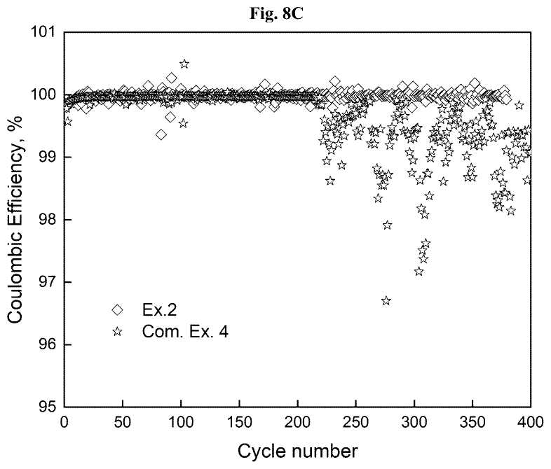

As shown in FIG. 8A, the coulombic efficiency (CE) of example 2 is consistently high and close to 100% while the comparative example 2 has a lower CE with less consistency. As shown in FIG. 8B, example 1 exhibits a consistently high CE with a value close to 100% while the comparative example 3 has a lower and less-consistent CE. As shown in FIG. 8C, example 2 exhibits a consistently high CE with a value close to 100% while the comparative example 4 has a lower and divergent CE.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. An electrolyte membrane comprising:
a) a sulfide solid electrolyte; and
b) a nonfibrillizable binder with a weight percentage in a range from 1.0 wt % to 10.0 wt % in the electrolyte membrane,
wherein the electrolyte membrane does not comprise a scaffold layer.

2. The electrolyte membrane of claim 1, wherein the sulfide solid electrolyte has a formula LiₓM1_{y}M2_{z}P₁₋ₚM3ₚS_{6-a-b-q}O_{q}ClₐBr_{b} (Formula I), wherein 4<x≤8, 0≤y<1, 0≤z<1, 0≤p<1, 0≤q<1, 0≤a≤2, 0≤b<2, 0<6−a−b−q<6, 0<1−p≤1, and wherein M1 is at least one element of Group 1 or Group 11 other than H or Li of the periodic table, M2 is at least one element of Group 2 of the periodic table, and M3 is at least one element of Group 14 of the periodic table.

3. The electrolyte membrane of claim 2, wherein 0≤b/a≤20.

4. The electrolyte membrane of claim 1, wherein the electrolyte membrane is a free-standing membrane.

5. The electrolyte membrane of claim 1, wherein the electrolyte membrane has a lithium-ion conductivity of at least 40% higher than that of one prepared with a scaffold layer.

6. The electrolyte membrane of claim 1, wherein the electrolyte membrane has a lithium-ion conductivity of at least 20% of that of powder of the sulfide solid electrolyte.

7. The electrolyte membrane of claim 1, wherein the electrolyte membrane has a lithium-ion conductivity in a range from 0.05 to 20 mS/cm.

8. The electrolyte membrane of claim 1, wherein the nonfibrillizable binder is made of a material selected from the group consisting of polyacrylate, styrene-butadiene rubber (SBR), poly(vinylidene fluoride) (PVDF), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, arylate copolymer, cellulose acetate, cellulose acetate butyrate, cellulose acetate propionate, polysaccharide polymer and carboxyl methyl cellulose, or a combination thereof.

9. The electrolyte membrane of claim 1, wherein the electrolyte membrane has a thickness in a range from 5 μm to 300 μm.

10. The electrolyte membrane of claim 1, wherein the sulfide solid electrolyte has a formula selected from the group consisting of:
i. LiₓPS_{6-a-b}ClₐBr_{b}, where 4≤x≤8, 0≤a≤2, 0≤b<2, 0<6−a−b<6;
ii. LiₓM1_{y}PS_{6-a-b}ClₐBr_{b}, where 4≤x≤8, 0<y<1, 0≤a≤2, 0≤b<2, 0<6−a−b<6;
iii. LiₓM2_{z}PS_{6-a-b}ClₐBr_{b}, where 4≤x≤8, 0<z<1, 0≤a≤2, 0≤b<2, 0<6-a-b<6;
iv. LiₓP₁₋ₚM3ₚS_{6-a-b}ClₐBr_{b}, where 4≤x≤8, 0<p<1, 0≤a≤2, 0≤b<2, 0<6−a−b<6, 0<1−p<1;
v. LiₓPS_{6-a-b-q}O_{q}ClₐBr_{b}, where 4≤x≤8, 0<q≤1, 0≤a≤2, 0≤b<2, 0<6−a−b−q<6;
vi. LiₓM1_{y}PS_{6-a-b-q}O_{q}ClₐBr_{b}, where 4≤x≤8, 0<y<1, 0<q<1, 0≤a≤2, 0≤b<2, 0<6−a−b−q<6;
vii. LiₓM2_{z}PS_{6-a-b-q}O_{q}ClₐBr_{b}, where 4≤x≤8, 0<z<1, 0≤q<1, 0≤a≤2, 0≤b<2, 0<6−a−b−q<6;and
viii. LiₓP₁₋ₚM3ₚS_{6-a-b-q}O_{q}ClₐBr_{b}, where 4≤x≤8, 0<p<1, 0<q<1, 0≤a≤2, 0≤b<2, 0<6−a−b−q<6, 0<1−p<1.

11. The electrolyte membrane of claim 1, wherein the sulfide solid electrolyte has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8}Br_{0.4}, Li_{5.8}PS_{4.8}Cl_{1.0}Br_{0.2}, and Li_{5.4}PS_{4.4}Cl_{1.4}Br_{0.2}.

12. An all solid-state battery (ASSB) comprising the electrolyte membrane of claim 1.

13. The ASSB of claim 12, wherein the ASSB exhibits at least one selected from the group consisting of:
a. an initial specific capacity of at least 180.0 mAh/g at a rate of C/3 at room temperature,
b. a specific capacity of at least 175 mAh/g after 100 cycles at a rate of C/3 at room temperature,
c. a specific capacity of at least 170 mAh/g after 300 cycles at a rate of C/3 at room temperature,
d. a specific capacity of at least 165 mAh/g after 400 cycles at a rate of C/3 at room temperature,
e. a capacity retention rate of at least 92.0% after 100 cycles at a rate of C/3 at room temperature,
f. a capacity retention rate of at least 91.5% after 300 cycles at a rate of C/3 at room temperature, and
g. a capacity retention rate of at least 89.5% after 400 cycles at a rate of C/3 at room temperature.

14. The ASSB of claim 12, wherein the ASSB exhibits a cycling life of at least 10% longer than that of one with an electrolyte membrane comprising a scaffold layer.

15. A method of preparing a solid membrane free of a scaffold layer, comprising:
a) mixing a nonfibrillizable binder, a solvent, and particles of a sulfide electrolyte to form a slurry;
b) coating the slurry on a non-stick base;
c) drying the coated slurry to form a dried coating on the non-stick base; and
d) peeling the dried coating from the non-stick base, thereby obtaining a solid electrolyte membrane free of scaffold layer.

16. The method of claim 15, wherein the non-stick base comprises a fluorinated ethylene propylene (FEP) copolymer, perfluoroalkoxy (PFA) polymer, ethylene tetrafluoroethylene (ETFE) copolymer, or a mixture thereof.

17. The method of claim 15, wherein the slurry comprises the solvent with a weight percentage in a range from 25% to 65%.

18. The method of claim 15, wherein the nonfibrillizable binder has a weight percentage of 1.0 wt % to 10.0 wt % in the solid electrolyte.

19. The method of claim 15, wherein the drying is vacuum drying conducted at room temperature.

20. An electrolyte membrane prepared according to the method of claim 15.
